(19) United States
(12) Patent Application Publication
(10) Pub. No.: US 2011/0289454 A1
(43) Pub. Date: Nov. 24, 2011

(54) METHOD AND DEVICE FOR RECORDING DATA REPRESENTING FEELINGS FELT BY PERSONS IN POSITIONABLE LOCATIONS, AND ASSOCIATED SERVER

(76) Inventors: Jean-Roch Houllier, Velizy (FR); Mounir Soudani, Nozay (FR)

(21) Appl. No.: 13/130,123

(22) PCT Filed: Nov. 19, 2009
(86) PCT No.: PCT/FR2009/052232

§ 371 Date: Aug. 8, 2011

(30) Foreign Application Priority Data
Nov. 19, 2008 (FR) 0857841

(51) Int. Cl. H04W 4/02; G06F 3/048

(52) U.S. Cl. 715/810; 455/456.1

(57) ABSTRACT

A method is dedicated for recording of data relating to positionable locations. Said method includes the following steps: i) recording main data, representing at least one feeling felt by a person in a location, using a radio communication terminal (T) used by said person and equipped with a positioning device (DL), ii) determining the geographical position of said location by means of the positioning device (DL) of the terminal (T), and iii) storing the main data recorded in correlation with said specific geographical position.

The invention relates to the field of recording data, and more particularly devices and methods making it possible to record data related to locatable locations.

Whenever a person moves within an outdoor or indoor environment, sometimes he or she feels a particular feeling in one particular location and might wish to keep a trace of that particular feeling for him/herself or for third parties. To do so, he or she must write the particular feeling and corresponding location in a notebook, or record an audio message describing the particular feeling and corresponding location using a tape recorder (or something similar), or take a photograph of the associated location independently from any base of records.

Regardless of the case in question, the usage by a third-party of the content of handwritten notes or on audio message or a photograph relating to a location proves difficult, because it requires not only digital re-transcription beforehand, but also determining the geographic coordinates of the location which had been described in words. A further problem involves making available to people in a given location information that has been associated with that location. This may, for example, be accomplished through having previously downloaded information related to locations. However, this implies that going past these locations was scheduled in advance, which is not always possible or desired.

The purpose of the invention, therefore, is to fully or partially remedy the abovementioned drawbacks.

To that end, it proposes a method devoted for recording data relating to positionable locations, comprising the following steps:
i) recording main data representing at least one feeling felt by a person in one place, by means of a radio communication terminal used by said person and equipped with a positioning device,
ii) determining the geographical position of said location by means of the positioning device of the terminal, and
iii) storing the main data recorded in correlation with said specific geographical position.

The method of the invention may comprise other characteristics, which may be taken separately or in combination, in particular:
in i) the person may select an experienced feeling from among a list of experienced feelings and/or a group of icons (or images), representing experienced feelings (“primary” or “secondary”) (to make input easier), from a menu which is displayed on the screen of his or her terminal;
in i) complementary data may be recorded which represents an intensity of a ecorded experienced feeling;
in i) the person may, for example, select the intensity of an experienced feeling from among a list of intensities from a menu which is displayed on the screen of his or her terminal;
in i) complementary data may be recorded which represent a description of the location and/or a recorded experienced feeling, and this complementary data may be associated with the main data of the feelings experienced and recorded in that location;
in i) at least one photographic recording may be taken in the location with a photograph device of the terminal; then the image data defining each photographic recording taken can be associated with the main data of the experienced feelings that had been recorded in that location;
in i) at least one audio recording may be taken in the location with an audio device of the terminal, then the image data defining each audio recording taken may be associated with the main data of the experienced feelings that had been recorded in that location;
in iii) the main data recorded by a person, and the associated complementary data if any, may be stored in a server as a match for the automatically determined geographic position and as a match for an identifier of that person;
a iv) may be provided in which a map, representing the zone including multiple locations associated with data recordings from at least one person, is generated; and on this map, chosen elements may be displayed, representing main data recorded by at least one person as well as associated complementary data if any, selected as a function of at least one chosen criteria, in the corresponding geographic positions;
a iv) may be provided in which a map, representing a zone including multiple locations associated with data recordings from at least one person, is generated; then within this map there may be defined subzones; then, for each subzone, an average value related to at least one chosen feeling experienced within that the subzone by at least one person may be determined; and each subzone may be assigned a marker representative of its determined average value, so as to display each subzone with the marker that was assigned to it:
at least one topical analysis (for example, by means of a publisher) may be performed for a given person.

The invention also discloses a device devoted to recording data related to locatable locations, koro radio communication terminal equipped with a location device, and comprising recording means tasked both with recording main data representative of at least one feeling experienced in one location by a person using that terminal, and also associating that main data with the geographic position of that location, as determined by the terminal's location device.

The inventive device may comprise other characteristics, which may be taken separately or in combination, in particular:
its means of recording may comprise selection means tasked with generating a menu intended to be displayed on the screen of the terminal and comprising a list of experienced feelings and/or a group of icons (or images) representative of experienced (“primary” or “secondary”) feelings within which the person may select at least one experienced feeling by means of a human/machine interface of his or her terminal;
its recording means may be tasked with additionally recording complementary data representative of an intensity of a recorded experienced feeling;
the selection means may be tasked with generating a menu intended to be displayed on the screen of the terminal and comprising a list of intensities of an experienced feeling within which the person may select an intensity of an experienced feeling by means of the human/machine interface of his/her terminal;
its recording means may be tasked with additionally recording complementary data representative of a description of the location and/or of a recorded experienced feeling and with associating this complementary data with the main data of the experienced feelings recorded in that location;
its recording means may be tasked with associating the main data of experienced feelings recorded in a location, with image data defining at least one photographic recording taken in that location with a photograph device of the terminal and/or audio data defining at least one audio recording taken in that location with an audio recording device of the terminal.

The invention also discloses a server, for a communication network, comprising storage means tasked with storing main data and associated complementary data if any, recorded as a match for a determined geographic position and a person's identifier, then transmitted by a radio communication terminal of that person equipped with a recording device of the type presented above.

Such a server may also comprise calculation means tasked with generating a map representing a zone including multiple locations associated with data recordings from at least one person, and with attaching to that map chosen elements representing main data recorded by at least one person as well as associated complementary data if any, selected as a function of at least one chosen criterion, at the corresponding geographic positions.

Furthermore, this server may also comprise calculation means tasked with i) generating a map representing a zone including multiple locations associated with data recordings from at least one person, ii) defining subzones within that map, iii) determining for each subzone an average value related to at least one chosen feeling experienced within that subzone by at least one person, and iv) assigning each subzone a marker representing its determined average value, such that each subzone can be displayed within its map with the marker that was assigned to it.

Other characteristics and advantages of the invention will become apparent upon examining the detailed description below, and the attached drawings, wherein:

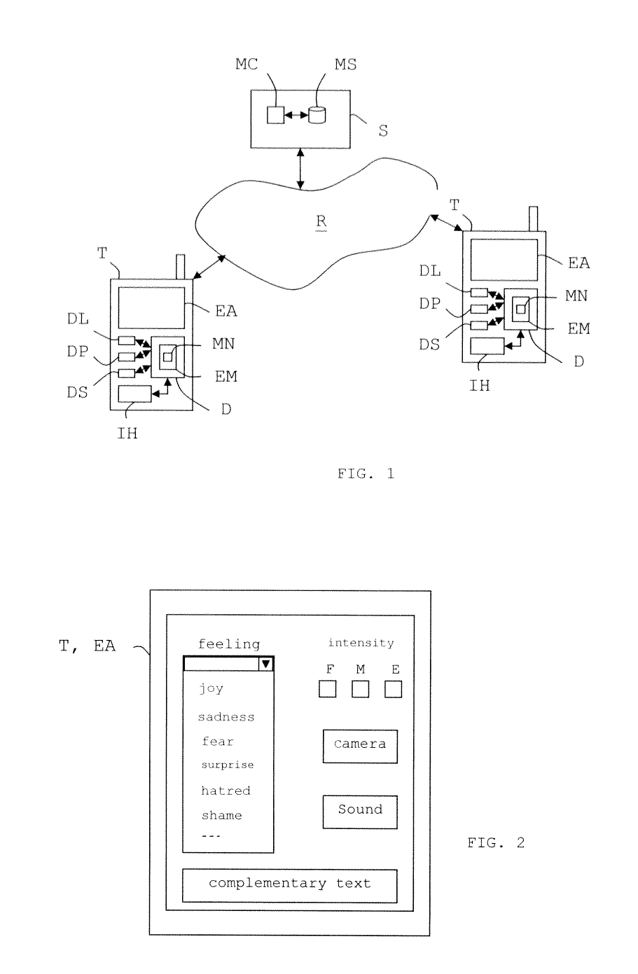

FIG. 1 schematically and functionally depicts a server according to the invention and mobile terminals, equipped with one example embodiment of an inventive recording device, coupled with a communication network,

FIG. 2 schematically depicts an example selection menu displayed on a mobile terminal screen,

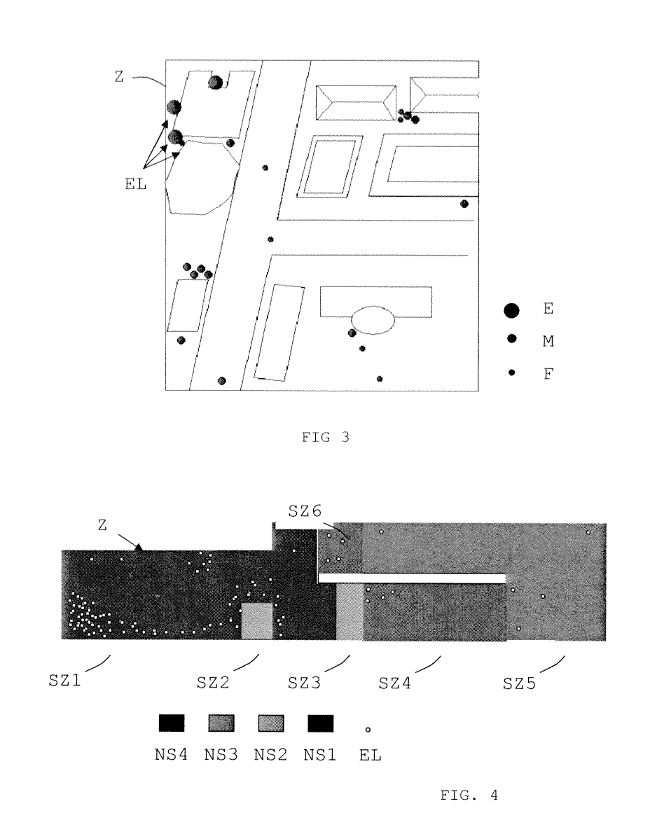

FIG. 3 schematically depicts a first example of a map representing a city zone, upon which are displayed a circular elements representing geographic positions of a person and whose dimensions represent the intensity of a feeling experienced locally by that person in different locations, and

FIG. 4 schematically depicts a second example of a map representing a zone of a museum divided into subzones in which are displayed circular elements representing geographic positions of people and whose shades of gray represent the average intensity of a feeling experience locally by a set of visitors.

The attached drawings may serve not only to complete the invention, but also to contribute to its definition as necessary.

One purpose of the invention is to enable the recording of data related to locatable locations, for the purpose of using this data and/or reusing it later.

We refer first to FIG. 1 in order to present the equipment involved in the implementation of the invention.

As schematically depicted, the implementation of the invention requires that people be equipped with a radio communication terminal T provided with a location device DL and which can preferentially connect to a radio communication network R.

Here, “location device” refers to a device capable of determining with a high degree of accuracy, typically on the order of one meter (or several meters), the position of the (radio communication) terminal T in which is installed. It may, for example, be a satellite location device, such as a GPS device. However, it may also be a passive or active RFID-chip radio device, installed in a terminal T and capable of reading, or receiving by means of waves, position data (or an identifier representing a position in a given reference base) stored in an RFID tag installed in a location.

In what follows, it is assumed by way of a non-limiting example that the radio communication terminals T are mobile (or cellular) telephones. However, the invention is not limited to this type of radio communication terminal. Rather, it encompasses any type of mobile or portable communication terminal that may connect by means of waves to a radio (or wireless) communication network or to any other radio communication device, and in particular portable computers and personal digital assistants (or PDAs) equipped with a radio communication module.

It should be noted that a radio communication terminal T (here, a mobile telephone), according to the invention, has at least one recording device D. a display screen EA, and a human/machine interface IH, enabling the person who uses it to control it, to enter alphanumeric data, and to select elements of menus displayed on the display screen EA, as well as potentially a photograph device DP, making it possible to take photographic recordings (image data files) or even video sequences (video data files) and/or an audio recording device DS, making it possible to take audio recordings (audiophiles) and therefore particularly comprising a microphone.

It should also be noted that the recording device D according to the invention which in a certain way constitutes a recording application, may either be coupled (or connected) to a mobile telephone T, or form an integral part of a mobile telephone T as depicted in non-limiting fashion in FIG. 1. Consequently, it may be constructed in the form of electronic circuits, software (or computer) modules, potentially downloaded ones, or a combination of circuits and software.

As depicted in FIG. 1, a recording device D according to the invention mainly comprises recording means (or a recording module) ME. This means or module (ME) is operative to implement at least two functions.

A first function consists of recording main data which represents at least one feeling (or impression) that was experienced in a location by a person who uses a mobile telephone T.

A second function of the recording means ME consists, each time that they have recorded main data in a location, of determining from the location device DL of their mobile telephone T, the coordinates of that location's geographic position, than associating this geographic position with this main recorded data.

Any type of feeling (or impression or emotion) that may be experienced by a person may be recorded. Thus, it may, for example, be, in a non-limiting fashion, joy, sadness, emotion, wonder, disgust, love, hatred, fear, surprise, revulsion, pride, nostalgia, jealousy, astonishment, admiration, respect, shame, envy, exasperation, or irritation. A feeling may be experienced “as it happens” in any location, whether it is outdoors, such as in front of a building, monument, or architectural structure, or in a neighborhood, park, site, or garden, or indoors, such as in a museum, an entertainment venue (movie theater, playhouse, opera), a store, a restaurant, a shop, a mall, a supermarket, a factory, a research center, or a place of worship.

Whenever a person wishes to record a feeling that he or she is experiencing in a location, he or she uses a computing-based recording application which is controlled by the recording means ME of his or her mobile telephone T. In one particularly simple embodiment, the recording application may, for example, once loaded, cause the mobile telephone T to display on the screen EA an input window in which the person is invited to enter a word or phrase defining an experience feeling by means of the human/machine interface IH of said mobile telephone T.

In one more sophisticated variant (depicted in FIG. 2), the recording means ME may comprise selection means (or module(s)) MN tasked with generating, if ordered by the loaded recording application, a menu (potentially a drop-down menu) which is intended to be displayed on the screen EA of the mobile telephone T and which comprises a list of experienced feelings and/or a group of icons (or images) facilitating input because they represent “primary” (meaning that they are considered the most important ones) or “secondary” (meaning that they are considered less important) experienced feelings, within which the person may make a selection of at least one experienced feeling by means of the human/machine interface IH of said mobile telephone T.

As depicted in a non-limiting fashion in FIG. 2, the selection means (or module(s)) MN may also be tasked with generating, if ordered by the loaded recording application, an input (“complementary text”) window in which the person is invited to enter complementary data representing the description of the location and/or a recorded (selected) experienced feeling by means of the human/machine interface IH of said mobile telephone T. In this situation, the recording means ME associate the complementary data, which was entered by the person into the window, with the main data of the experienced feeling(s) that that person recorded (selected) in the location in question.

It should be noted that the recording means (or module) ME may also be operative to record complementary data which represents the intensity of the experienced feeling that the person recorded (selected). To do so, and as depicted in a non-limiting fashion in FIG. 2, the selection means (or module(s)) MS may be configured so as to generate a menu (potentially a drop-down menu) which is intended to be displayed on the screen EA of the mobile telephone T and which comprises a list of experienced feeling intensities within which the person may select an intensity for the selected experienced feeling, by means of the human/machine interface IH of said mobile telephone T. For example, and as depicted, a choice of three intensities [low (F), medium (M) and high (E)] may be displayed and offered to the person. The selected intensity (complementary data) is then immediately associated by the recording means (ME) with the previously selected experienced feeling (main data) as well as the geographic position of the location (provided by the location device DL of the mobile telephone T).

It should also be noted that when the mobile telephone T is equipped with a photograph device DP and/or an audio recording device DS, the recording means ME may be operative to associate the main data of an experienced feeling, recorded (selected) in a location, with image (or file) data defining at least one photographic recording taken in that location with the photograph device DP and/or audio (or file) data defining at least one audio recording taken in that location with an audio recording device DS. To do so, and as depicted in a non-limiting fashion in FIG. 2, the selection means (or module(s)) MS may be operative to generate a selectable icon which is intended to be displayed on the screen EA of the mobile telephone T and which invites the person to take a photograph (or a video sequence) and/or a selectable icon which is intended to be displayed on the screen EA of the mobile telephone T in which invites the person to record the sounds in his or her environment. For example, if the photograph icon is selected by the person, the recording application loads the photographic application that controls the photograph device DP, then, once the person has taken at least one photograph (ora video sequence), the recording means ME associated the recorded photographic or video file with the main data of the previously selected experienced feeling and with the geographic position of the location (provided by the location device DL of the mobile telephone T), as well as with other complementary data if any (intensity and/or description).

By way of example, a description (complementary data), associated with a feeling experienced in a location, may, for example, refer to a photograph or a recorded audio sequence. For example, a person may enter a verbal phrase like “I was very shocked by a driver's attitude (see associated photo)”, or “I was moved by the quality of the interpretation by the organist who was playing in this church (listen to the associated audio sequence)”, or “Miro's Bleu II is really exceptional (see associated photo)”.

It is important to note that due to the difficulties encountered by GPS-type devices at operating indoors, it is conceivable, as indicated above, to install in some locations (such as, for example, in museums, expositions, or supermarkets) radio tags (such as RFID tags) capable of providing (spontaneously or if queried) position data (or identifiers representing a position) to mobile telephones T equipped with a location device DL adapted to that purpose.

It should be noted that the main data and the data defining the geographic position of the associated location, as well as associated complementary data if any (intensity and/or description) may be stored in the mobile telephone T so that it can be used or reused later by at least one local application of said mobile telephone T that takes into account the data associated with geographic positions. However, this data may also be transmitted to a server S (or to another radio communication device) by the mobile telephone T, upon the request of its recording device D and via the communication network R to which that mobile telephone (T) is connected. It should be understood that such a server S is either connected to the communication network R or is accessible to that network (for example, via the Internet). This server S may, for example, be an application server that receives and stores recording data before offering it, potentially over the Internet (for example, via a webpage), and potentially in a shared form.

This server S therefore comprises at least storage means MS tasked with storing the data recorded and then transmitted by the mobile telephones T. More precisely, these storage means MS store the main data and any associated complementary data, as a match for the geographic positions of the associated locations and for the identifiers of the people who use the mobile telephones T that transmit them. In other terms, the recording data is geo-referenced in order to be used or reused, such as on a map background or a chosen base map.

Any type of storage means MS known to the person skilled in the art may be used, and particularly a memory or database.

The stored data may then be used by local applications of the server S or even remote applications, which may be installed in other servers or (radio or non-radio) is communication terminals.

For example, the server S may also comprise a calculation module (or application) MC which is tasked with generating upon request a map that represents a zone Z including multiple locations with which data recordings from at least one person have been associated. Any type of map may be conceived, whether two-dimensional (2D) or three-dimensional (3D). Thus, a map may depict the outlines of one or more neighborhoods of a city or buildings of a city neighborhood, or the different floors (or storeys) of a museum or store or shopping mall, or the various subsections of one or more floors (or storeys) of a museum or store or shopping mall.

The calculation module MC is also tasked with attaching to the map that it has generated, chosen elements EL which represent main data and associated complementary data if any, recorded by at least one person (and stored in the storage means MS) and selected as a function of at least one chosen criterion. It should be understood that these chosen elements EL are then displayed on the map in the geographic positions that match the ones of the locations where the data they represent was recorded. The map thereby constitutes a sort of consolidation of previously recorded data (potentially over a chosen interval of time). It may particularly enable a person to return to a location where he or she (or another person) had previously experienced a particular feeling.

It should be noted that it is also possible, when the recorded data is stored as a match for a date, to perform map comparisons integrating recording data obtained at different dates. This may actually make it possible to perform so-called “time-to-time” analyses (an analysis of a change over time in the feelings experienced in a single zone), particularly helpful for museum curators or supermarket managers (in particular for the purpose of topical studies or marketing).

Any type of chosen element EL may be used, and particularly geometric elements, such as circles, squares, triangles, or stars.,

Any type of criterion having a relationship with at least one experienced feeling and/or at least one interval of time and/or at least one group of people and/or at least one location may be used. Thus, a criterion may consist of selecting all the locations of a city neighborhood or a city where a given person (identified by his or her personal identifier) experienced one or more feelings, potentially selected ones, or one single feeling regardless of its intensity. This last selection criterion is the one which was used to create the map in FIG. 3. More specifically, the circles EL are chosen elements which represent the different locations of a neighborhood where a single person recorded experienced feelings, and the respective dimensions of these circles EL represent the intensities at which that person experienced those feelings.

Another criterion may consist of selecting all of the locations of a museum floor or a museum where people experienced one or more feelings, potentially selected ones, and/or potentially with at least one selected intensity. This situation may require that the people agree to share their data anonymously.

Yet another criterion may consist of selecting all the locations of a city neighborhood or a city or a museum floor where people have felt at least one single feeling selected for the purpose of drawing comparisons or behavioral correlations between people (for example, within community or meet-up sites). This situation may require that the people agree to share their data.

It should be noted that the calculation module MC may also be tasked with defining subzones SZi (i=1 to N) within a map of a zone Z, then with determining for each subzone SZi the mean value of the intensities associated by people with a single chosen feeling experienced within that subzone SZi, and assigning to each subzone SZi a marker representing its average determined intensity. Thus, each subzone SZi may be displayed within its map with the marker that was assigned to it. Such an example map is depicted in FIG. 4. More specifically, the circles EL are chosen elements which represent the different locations of the museum floor where people have recorded a single experienced sentiment, and the four different shades of gray NSj (j=1 to 4) respectively represent four average intensity values of that feeling experienced within six subzones SZi (here i=1 to 6). Naturally, any type of marking may be used. This situation may require that the people agree to share their data anonymously.

This type of map may advantageously be used by organizers of artistic expositions or museum curators for determining which works and/or artists that please the most visitors, or which indoor layouts are the most-appreciated or best-suited to the needs of visitors.

By way of a non-limiting example, a cartographic application programming interface (or API) such as the one of the type offered by Google Earth®, may make it possible to attach chosen elements EL to the corresponding geographic positions of an outdoor map previously obtained by means of an observation satellite.

It should be noted that comparisons or correlations may be made between maps created from identical or different criteria. Likewise, combinations or aggregations of maps corresponding to different areas may potentially be made.

It should also be noted that the data recorded by a person may potentially be associated with his or her avatar within a networked game or a social network, therefore establishing a bridge between the real world and a virtual world. More specifically, the moods of a person's avatar may be representative of the feelings experienced (felt) and recorded by that person and then stored in a server S (then potentially in a community site). It should be noted that some feelings of a personal nature might be reserved solely for the use of the person in question (or a predefined group of friends or acquaintances), while some other (“less” personal) feelings may be shared and can therefore be associated with that person's avatar.

It should also be noted that the recording data may potentially be recorded by volunteer people within big-box stores (or supermarke(s) or shops in order to determine which products make the customers the most pleased, or which internal layouts are the most-appreciated or the best-suited to customers' needs. In this situation, the radio communication terminals T may potentially be loaned out to volunteer customers, and the recording data may for example be uploaded from the terminals T to a piece of radio communication equipment.

Generally speaking, the calculation module MC may be operatives to conduct any type of analysis on recording data, for the purpose of any topical display whatsoever. Thus, each person may, for example, build his or her own personal map of feelings, which may potentially be made available on a personal webpage, or request a topical analysis, for example to obtain a map of emotional cold and/or hot zones, potentially built based on the areas resulting from densities of underlying points.

Furthermore, it should be noted that a map may be dynamic if it is built in real time (meaning as successive recordings are made). Consequently, the associated topical analyses may also be dynamic. In this case, each person may use his or her map of feeling(s) in various environments (or applications), including in the course of comparisons via community sites.

The calculation module MC of the server S according to the invention may be constructed in the form of electronic circuits, software (or computing) modules, or a combination of circuits and software.

It is important to note that the invention may also be considered from the standpoint of a recording method, than may particularly be implemented by means of radio terminals T equipped with a recording device D of the type described above, and potentially a server S of the type described above. As the functionalities provided by the implementation of the method according to the invention are identical to those provided by the device D introduced above, only the combination of the main functionalities provided by the method is presented hereafter.

This method includes the following steps:
i) recording main data representing at least one feeling felt by a person in one location, by means of a radio communication terminal T used by that person and equipped with a location device DL,
ii) determining the geographic position of that location by means of the location device DL of the terminal T, and
iii) storing the recorded main data as a match for the determined geographic position.

The invention is not limited to the embodiments of the recording method, recording system, and server described above, which are only given by way of example; rather, it encompasses all variants that a person skilled in the art may envision within the framework of the claims below.

1. A method devoted to recording data related to locatable locations, wherein it comprises the following steps: i) recording main data representing at least one feeling felt by a person in a location, by means of a radiocommunication terminal (T) used by said person and equipped with a positioning device (DL), ii) determining the geographical position of said location by means of the positioning device (DL) of the terminal (T), and iii) storing the main data recorded in correlation with said specific geographical position.

2. A method according to claim 1, wherein during i) said person selects an experienced feeling from among a list of experienced feelings and/or a group of icons, representing experienced feelings, from a menu which is displayed on the screen (EA) of his or her terminal (T).

3. A method according to claim 1, wherein during i) complementary data may be recorded which represents an intensity of a recorded experienced feeling.

4. A method according to claim 3, wherein during i) said person selects the intensity of an experienced feeling from a list of intensities from a menu displayed on the screen (EA) of his or her terminal (T).

5. A method according to claim 1, wherein during i) complementary data is also recorded which represents a description of said location and/or a recorded experienced feeling, and this complementary data is associated with the main data of said feelings experienced and recorded in said location.

6. A method according to claim 1, wherein during i) at least one photographic recording is taken in said location with a photograph device (DP) of said terminal (T); then the image data defining each photographic recording taken is associated with the main data of said experienced feelings that had been recorded in said location.

7. A method according to claim 1, wherein during i) at least one sound recording is taken in said location with an audio recording device (DS) of said terminal (T); then the audio data defining each audio recording taken is associated with the main data of said experienced feelings that had been recorded in said location.

8. A method according to claim 1, wherein during iii) said main data recorded by a person, and said associated complementary data if any, are stored in a server as a match for the automatically determined geographic position and as a match for an identifier of that person.

9. A method according to claim 1, wherein a iv) is provided in which a map, representing the zone including multiple locations associated with data recordings from at least one person, is generated; and on said map, chosen elements may be displayed, representing main data recorded by at least one person as well as associated complementary data if any, selected as a function of at least one chosen criteria, in the corresponding geographic positions.

10. A method according to claim 1, wherein a iv) is provided in which a map, representing a zone including multiple locations associated with data recordings from at least one person, ii) defining subzones within said map, iii) determining for each subzone an average value related to at least one chosen feeling experienced within that subzone by at least one person, and iv) assigning each subzone a marker representing its determined average value, such that each subzone can be displayed within its own map with the marker that was assigned to it.

11. A device (D) to record data relating to locatable locations, for a radio communication terminal (T) equipped with a location device (DL), wherein it comprises recording means (ME) tasked both with i) recording main data representative of at least one feeling experienced in one location by a person using said terminal (T), and also associating that main data with the geographic position of said location, as determined by the terminal's (T) location device (DL).

12. A device according to claim 11, wherein said recording means (ME) comprise selection means (MS) operative to generate a menu intended to be displayed on the screen (EA) of said terminal (T) and comprising a list of experienced feelings and/or a group of icons representative of experienced feelings, within which said person may select at least one experienced feeling by means of a human/machine interface (IH) of his or her terminal (T).

13. A device according to claim 11, wherein said recording means (ME) are operative to additionally record complementary data representative of a description of an intensity of a recorded experienced feeling.

14. A device according to claim 13, wherein said selection means (MS) are operative to generate a menu intended to be displayed on the screen (EA) of said terminal (T) and comprising a list of intensities of an experienced feeling within which said person may select an intensity of an experienced feeling by means of the human/machine interface (IH) of his/her terminal (T).

15. A device according to claim 11, wherein said recording means (ME) are operative to additionally record complementary data representative of a description of said location and/or of a recorded experienced feeling and to associate this complementary data with the main data of said experienced feelings recorded in said location.

16. A device according to claim 11, wherein said recording means (ME) are operative to associate the main data of experienced feelings recorded in a location, with image data defining at least one photographic recording taken in said location with a photograph device (D) of said terminal (T) and/or audio data defining at least one audio recording taken in that location with an audio recording device (DS) of said terminal (T).

17. A server (S) for a communication network (R), wherein it comprises storage means (MS) tasked with storing main data and associated complementary data if any, recorded as a match for a determined geographic position and a person's identifier, then transmitted by a radio communication terminal (T) of that person equipped with a recording device (D) to record data relating to locatable locations, for a radio communication terminal (T) equipped with a location device (DL), wherein it comprises recording means (ME) tasked both with i) recording main data representative of at least one feeling experienced in one location by a person using said terminal (T), and also associating that main data with the geographic position of said location, as determined by the terminal's (T) location device DL.

18. A server according to claim 17, wherein it comprises calculation means (MC) operative to generate a map representing a zone (Z) including multiple locations associated with data recordings from at least one person, and to attach to that map chosen elements representing main data recorded by at least one person as well as associated complementary data if any, selected as a function of at least one chosen criterion, at the corresponding geographic positions.

19. A server according to claim 17, wherein it comprises calculation means (MC) operative to i) generate a map representing a zone (Z) including multiple locations associated with data recordings from at least one person, ii) define subzones (SZi) within said map, iii) determine for each subzone (SZi) an average value related to at least one chosen feeling experienced within that subzone (SZi) by at least one person, and iv) assigning each subzone (SZi) a marker representing its determined average value, such that each subzone (SZi) can be displayed within its map with the marker that was assigned to it.
